(19) United States
(12) Patent Application Publication
(10) Pub. No.: US 2025/0233233 A1
(43) Pub. Date: Jul. 17, 2025

(54) SUPERBEAM DESIGN FOR CYLINDRICAL BATTERY CELL ASSEMBLY

(71) Applicant: GM GLOBAL TECHNOLOGY OPERATIONS LLC, Detroit, MI (US)

(72) Inventors: Hui-ping WANG, Troy, MI (US); Lu HUANG, Troy, MI (US); David R. CLARK, Grosse Pointe Woods, MI (US); Travis J. SHEPHERD, Philadelphia, PA (US); Chengwu DUAN, Shanghai (CN); Yunzhi XU, Troy, MI (US); Blair E CARLSON, Ann Arbor, MI (US)

(21) Appl. No.: 18/618,370

(22) Filed: Mar. 27, 2024

(30) Foreign Application Priority Data
Jan. 15, 2024 (CN) 2024100606655

(51) Int. Cl. H01M 10/6557; H01M 10/613; H01M 10/643; H01M 10/6555; H01M 50/213; H01M 50/224; H01M 50/229; H01M 50/431; H01M 50/463

(52) U.S. Cl. CPC H01M 10/6557; H01M 10/613; H01M 10/6555; H01M 50/224; H01M 50/229; H01M 50/431; H01M 50/463; H01M 10/643; H01M 50/213

(57) ABSTRACT

A rechargeable energy storage system includes a housing including a tray and a sidewall structure. A plurality of beam assemblies extend in parallel across the housing, the plurality of beam assemblies each include a bottom cap having a base plate and pair of parallel ribs extending from the base plate. A coolant passage plate is sandwiched between a pair of undulating plates with a first end disposed between the pair of parallel ribs of the bottom cap. The coolant passage plate is connected to a coolant source. A plurality of battery cells are disposed in the housing and in contact with the undulating plates of adjacent beam assemblies.

### CROSS-REFERENCE TO RELATED APPLICATIONS

This application claims the benefit of Chinese Patent Application No. 202410060665.5, filed on Jan. 15, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a cooling beam design for battery cell assemblies.

Ribbons are commonly utilized in cylindrical cell battery assemblies to facilitate cell cooling. However, there are several existing issues with the ribbons. First, they lack structural rigidity. Second, they require attachment to the cell walls during assembly as they cannot stand independently. Third, due to the predefined positions of cells by the cell holders during assembly, the ribbons do not establish tight contact on both sides with the cells, potentially compromising cooling performance.

### SUMMARY

A rechargeable energy storage system includes a housing including a tray and a sidewall structure. A plurality of beam assemblies extend in parallel across the housing, the plurality of beam assemblies each include a bottom cap having a base plate and pair of parallel ribs extending from the base plate. A coolant passage plate is sandwiched between a pair of undulating plates with a first end disposed between the pair of parallel ribs of the bottom cap. The coolant passage plate is connected to a coolant source. A plurality of battery cells are disposed in the housing and in contact with the undulating plates of adjacent beam assemblies.

According to another aspect, a top cap includes a base plate and a pair of parallel ribs extending from the base plate, the top cap disposed over a second end of the undulating plates with the pair of parallel ribs on opposite sides of the pair of undulating plates.

According to another aspect, ends of the top cap are connected to the sidewall structure

According to another aspect, the pair of undulating plates have a thickness ranging from 1 mm to 1.5 mm.

According to another aspect, the coolant passage plate has a thickness ranging from 0.3 mm to 0.6 mm.

According to another aspect, the bottom cap of the plurality of beam assemblies are secured to the tray.

According to another aspect, one of an adhesive or foam is disposed between the pair of parallel ribs of the bottom cap.

According to another aspect, the bottom cap is made from extruded aluminum.

According to another aspect, the bottom cap is made from composite material.

According to another aspect, the plurality of battery cells are supported on top of one of the pair of ribs of adjacent beam assemblies.

According to another aspect, a vent channel is disposed between bottom caps of adjacent beam assemblies.

According to another aspect, the plurality of beam assemblies include a pair of coolant passage plates sandwiched between the pair of undulating plates.

According to another aspect, the coolant passage plate is made from an elastic material.

According to another aspect, the coolant passage plate is made from one of a composite and a polymeric material.

According to another aspect, the pair of undulating plates are made from metal.

According to another aspect, the pair of undulating plates are made from one of a composite and polymeric material and the coolant passage plate is made from metal.

According to another aspect, a coolant connector in communication with each coolant passage plate.

According to another aspect, the coolant connectors of each coolant passage plate are connected to a coolant source.

According to another aspect, the coolant connectors of each coolant passage plate are connected to coolant connectors of adjacent beam assemblies.

According to another aspect, ends of the bottom caps of the plurality of beam assemblies are connected to the sidewall structure.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a portion a battery cell assembly with beam battery separators according to the principles of the present disclosure;

FIG. 2 is a perspective view of a beam assembly according to the principles of the present disclosure;

FIG. 3 is an exploded isometric view of the beam assembly according to the principles of the present disclosure;

FIG. 4 is an end plan view of the battery cells separated by the super beam assembly according to the principles of the present disclosure;

FIG. 5 is a perspective view of a plurality of rows of batteries separated by beam assemblies according to the principles of the present disclosure; and

FIG. 6 is a perspective view of a plurality of rows of batteries separated by beam assemblies including an optional top cap according to the principles of the present disclosure.

In the drawings, reference numbers may be reused to identify similar and/or identical elements.

### DETAILED DESCRIPTION

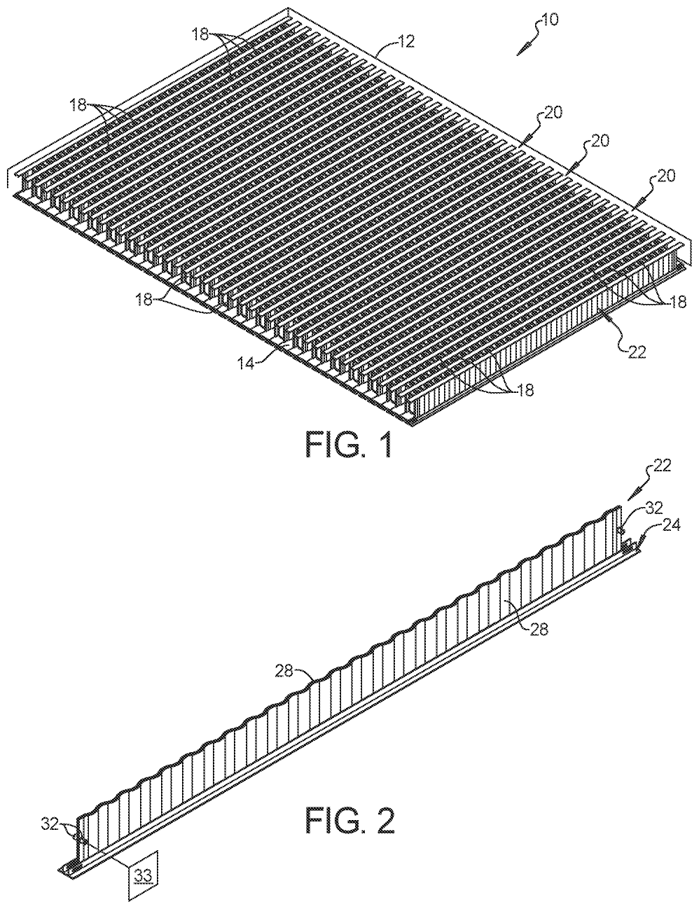

With reference to FIG. 1, a portion of a rechargeable energy storage system 10 is shown including a wall structure 12 (part of which is shown) surrounding a tray 14 on which a plurality of battery cells 18 are aligned. The battery cells 18 are aligned in a plurality of rows 20 that are each separated by a beam assembly 22 according to the principles of the present disclosure.

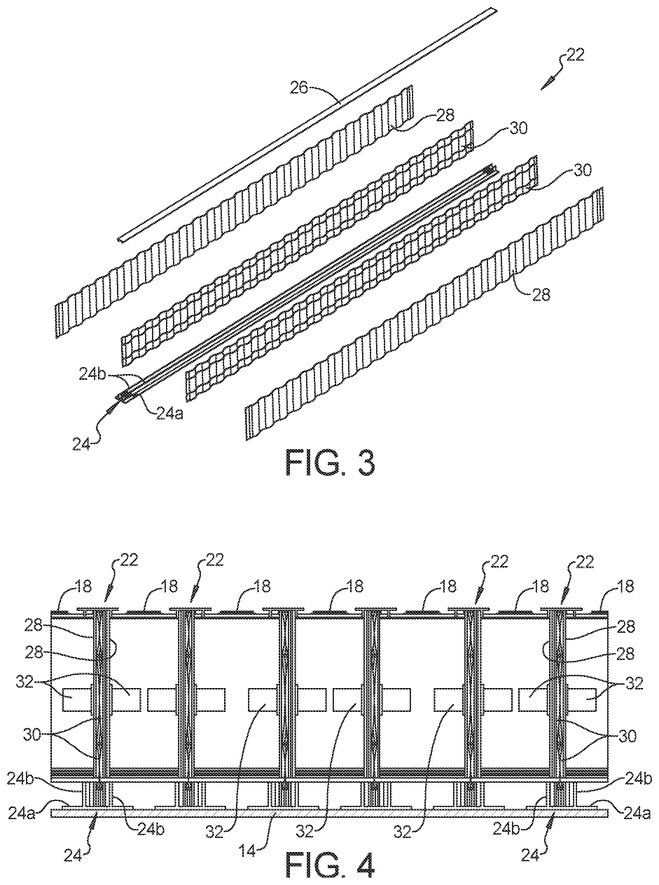

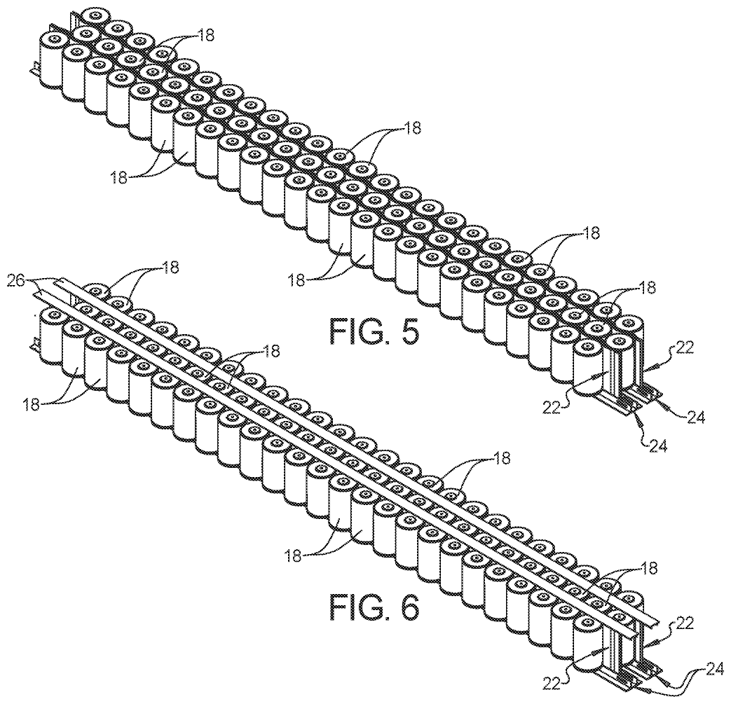

With reference to FIG. 3, each beam assembly 22 includes a bottom cap 24, an optional top cap 26 (See FIG. 6), a pair of undulating face plates 28 and a pair of coolant passage plates 30. The curvatures of undulating face plates 28 are designed to conform to the exterior walls of the cylindrical battery cells 18 after assembly. The bottom cap 24 of the beam assembly includes a base plate 24a and a pair of spaced ribs 24b extending from the base plate 24a. The bottom cap 24 can be constructed from either an extruded aluminum piece or composite material. The bottom cap 24 secures the pair of undulating face plates 28 and the pair of coolant passage plates 30 in position. Foam or adhesive material can be dispensed into the gap between the pair of spaced ribs 24b of the bottom cap 24 to further secure the undulating face plates 28 and the coolant passage plates 30. The bottom of the bottom cap 24 is affixed to the battery tray 14 through welding or adhesive bonding. If required, the bottom cap 24 can be integrated into the design of the bottom shear plate. The bottom cap 24 provides structural rigidity to safeguard the battery cells 18 against side and bottom impacts. Furthermore, the bottom cap 24 serves as a platform for the battery cells 18 to rest on during assembly.

The pair of coolant passage plates 30 possess the ability to be compressed along the normal direction of the beam assembly 22, providing elasticity during both assembly and battery service. The cooling channels are formed between the face plate 28 and its corresponding coolant passage plate 30 so that the cooling agent such as coolant can flow in and out of the channels to take heat away from the face plates 28 contacting the battery cells 18 during cooling and bring heat in during heating. While the primary function is providing cooling/heating. The secondary function of the pair of coolant passage plates 30 is to establish a tight contact between the undulating face plates 28 and the walls of the battery cells 18, thereby optimizing the cooling effect. The coolant passage plates 30 can be fabricated using aluminum materials, polymer materials or composite materials. Alternatively, a combination of materials can be employed, with the pair of undulating face plates 28 made of composite or polymer materials and the coolant passage plate made of metallic materials. The undulating face plates 28 can be either stamped or extruded, while the coolant passage plates can be stamped or otherwise formed from layered materials. The coolant passage plates 30 and the undulating face plates 28 can be joined together using brazing, welding, or adhesive bonding methods.

The bottom and top caps 24, 26 are designed to contact the side walls 12 of the battery tray at their respective ends for load bearing/passing, the undulating plates 28 and the coolant passage plates 30 each have a shortened length to avoid engaging in any load-bearing function to protect the cooling channels and connections. The coolant passage plates 30 include coolant connectors 32 that are positioned at the two end portions of the coolant passage plates 30, either on the sides or ends. The coolant connectors 32 of adjacent beam assemblies 22 can be connected to one another and the coolant connectors can all be connected to a coolant source 33. A height of the beam assembly 22 is specifically designed to allow space on the top for the installation of busbars or other needs. The top cap 26 (see FIG. 6), which is optional, serves to enhance structural rigidity and restrict vertical movement of the battery cells 18. The top cap 26 can be constructed from either an extruded aluminum piece or composite material and has the same shape as the bottom caps 24. The top cap 26 tightly envelops the pair of undulating plates 28 and the pair of coolant passage plates 30 from the top, and adhesive can be used to ensure a secure connection between the pair of undulating plates 28, the pair of coolant passage plates 30 and the top cap 26. Additionally, the top cap 26 can be connected to a top shear plate of the battery module housing using extended flanges and mechanical bolts.

The concept of a modular assembly can be employed when assembling the beam assemblies 22 and cylindrical battery cells 18 into the battery packs. The beam assemblies 22 are pre-assembled into an interim structure with slight compression and then inserted into the battery tray 14. Laser tack welding can be performed to secure the beam positions by connecting the bottom cap 24 to the tray. Another option would be adhesively bonding the bottom caps 24 to the tray 14. The ends of the bottom cap 24 and the top cap can be connected to the sidewall structure 12 by brackets and/or other fasteners. This ensures that the battery cells 18 have tight contact with the beam assemblies 22 once the coolant is filled by the coolant source. The beam assemblies 22 enable cell holding, effective cooling and protection of cylindrical battery cells 18 in a battery pack. The channels (see FIG. 4) formed between bottom caps 24 also serve as ideal thermal runaway outgassing routes when isolation plates with venting holes are used at the bottom of the battery cells during assembly to allow battery cell downward outgassing.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A rechargeable energy storage system comprising:
a housing including a tray and a sidewall structure;
a plurality of beam assemblies extending in parallel across the housing, the plurality of beam assemblies each including a bottom cap having a base plate and pair of parallel ribs extending from the base plate, a coolant passage plate is sandwiched between a pair of undulating plates with a first end disposed between the pair of parallel ribs of the bottom cap, wherein the coolant passage plate is connected to a coolant source; and
a plurality of battery cells disposed in the housing and in contact with the undulating plates of adjacent beam assemblies.

2. The rechargeable energy storage system according to claim 1, further comprising a top cap having a base plate and a pair of parallel ribs extending from the base plate, the top cap disposed over a second end of the undulating plates with the pair of parallel ribs on opposite sides of the pair of undulating plates.

3. The rechargeable energy storage system according to claim 2, wherein ends of the top cap are connected to the sidewall structure.

4. The rechargeable energy storage system according to claim 1, wherein the pair of undulating plates have a thickness ranging from 1 mm to 1.5 mm.

5. The rechargeable energy storage system according to claim 1, wherein the coolant passage plate has a thickness ranging from 0.3 mm to 0.6 mm.

6. The rechargeable energy storage system according to claim 1, wherein the bottom cap of the plurality of beam assemblies are secured to the tray.

7. The rechargeable energy storage system according to claim 1, further comprising one of an adhesive or foam between the pair of parallel ribs of the bottom cap.

8. The rechargeable energy storage system according to claim 1, wherein the bottom cap is made from extruded aluminum.

9. The rechargeable energy storage system according to claim 1, wherein the bottom cap is made from composite material.

10. The rechargeable energy storage system according to claim 1, wherein the plurality of battery cells are supported on top of one of the pair of ribs of adjacent beam assemblies.

11. The rechargeable energy storage system according to claim 1, further comprising a vent channel disposed between bottom caps of adjacent beam assemblies.

12. The rechargeable energy storage system according to claim 1, wherein the plurality of beam assemblies include a pair of coolant passage plates sandwiched between the pair of undulating plates.

13. The rechargeable energy storage system according to claim 1, wherein the coolant passage plate is made from an elastic material.

14. The rechargeable energy storage system according to claim 1, wherein the pair of undulating plates are made from metal.

15. The rechargeable energy storage system according to claim 1, further comprising a coolant connector in communication with each coolant passage plate.

16. The rechargeable energy storage system according to claim 15, wherein the coolant connectors of each coolant passage plate are connected to a coolant source.

17. The rechargeable energy storage system according to claim 15, wherein the coolant connectors of each coolant passage plate are connected to coolant connectors of adjacent beam assemblies.

18. The rechargeable energy storage system according to claim 1, wherein ends of the bottom caps of the plurality of beam assemblies are connected to the sidewall structure.

19. A rechargeable energy storage system comprising:
a housing including a tray and a sidewall structure;
a plurality of beam assemblies extending in parallel across the housing, the plurality of beam assemblies each including a bottom cap having a base plate and pair of parallel ribs extending from the base plate, a coolant passage plate is sandwiched between a pair of undulating plates with a first end disposed between the pair of parallel ribs of the bottom cap, wherein the coolant passage plate is connected to a coolant source;
a plurality of battery cells disposed in the housing and in contact with the undulating plates of adjacent beam assemblies, wherein the plurality of battery cells are supported on top of one of the pair of ribs of adjacent beam assemblies; and
a coolant connector in communication with each coolant passage plate,
wherein the coolant connectors of each coolant passage plate are connected to a coolant source.

20. The rechargeable energy storage system according to claim 19, wherein the coolant passage plate is made from an elastic material.
